(19) United States
(12) Patent Application Publication
(10) Pub. No.: US 2008/0272584 A1
(43) Pub. Date: Nov. 6, 2008

(54) Method for advertising tissue products

(76) Inventors: Carolyn Marie Eisele, Neenah, WI (US); James Craig Matheson, Green Bay, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/897,091

(22) Filed: Aug. 28, 2007

Related U.S. Application Data
(60) Provisional application No. 60/927,142, filed on May 1, 2007.

(51) Int. Cl. B42D 15/00

(52) U.S. Cl. 283/56; 281/15.1

(57) ABSTRACT

A tissue basesheet is printed with advertising text and/or graphics and bound into a magazine as one of several pages of advertising in the magazine to enable the reader to feel what the actual tissue product feels like.

Applicants hereby claim the benefit of presently co-pending U.S. Provisional Application Ser. No. 60/927,142 filed on May 1, 2007. The entirety of U.S. Provisional Application Ser. No. 60/927,142 is hereby incorporated by reference.

### BACKGROUND OF THE INVENTION

In the tissue industry, manufacturers continually strive to improve brand awareness among consumers through various forms of advertising. For tissue products, such as facial tissue, bath tissue and paper towels, some product characteristics can be adequately conveyed by conventional print or television advertising. However, for some tissue products the feel of the product, such as softness, is difficult or impossible to adequately convey by conventional means. Therefore there is a need for a method of advertising which enables the consumer to adequately evaluate the tactile properties of tissue products.

### SUMMARY OF THE INVENTION

It has now been discovered that merely feeling the surface of a tissue product, such as by touching a small product sample glued to a magazine page, is not sufficient for products which not only have a soft surface, but are also very cloth-like and flexible. For such products, it is necessary to enable the consumer to actually feel and handle the product.

Hence in one aspect, the invention resides in a method of advertising one or more products, such as tissue products, comprising binding one or more representative sheets, such as tissue sheets (hereinafter defined), within a magazine along only one edge, wherein a reader of the magazine can manipulate the bound sheets in his/her hand to assess hand feel and softness. In particular, the representative sheets are not actual samples of the product, but instead are basesheets that are custom cut, suitably cut to the same size as the pages in the magazine, and which may contain advertising that complements or coordinates with advertising provided in preceding and/or subsequent pages of the magazine, if present. As used herein, consistent with ordinary usage, a “page” is one side of a sheet. As a result, each bound sheet provides two consecutive pages.

In another aspect, the invention resides in a method of advertising a product, such as a tissue product, comprising: (a) forming a roll of a sheet material, such as a parent roll of a tissue basesheet; (b) unwinding the roll and slitting the unwound sheet into multiple sheets of desired width; (c) winding a slit sheet into a roll; (d) unwinding the sheet and printing at least one side of the sheet with advertising text and/or graphics; (e) slitting the printed sheet to a selected width suitable for use as a page in a magazine; (f) winding a printed/slit sheet into a roll; (g) unwinding the printed sheet and sandwiching and binding the printed sheet between two paper cover sheets along a common edge to form a composite, optionally one or both of said cover sheets comprising advertising for the product; (h) cutting the composite to a size suitable for being bound into a magazine; and (i) binding the composite into a magazine along the bound common edge of the composite. Some of the foregoing winding/unwinding steps may be eliminated depending upon how many locations and/or parties are involved in the overall process. The various steps in the foregoing method reflect the involvement of a tissue manufacturer or other sheet manufacturer, a converter, a converter/printer and a publisher. Because the amount of sheets involved for advertising is small, the printing is customized and the page size can vary among different magazines, the use of custom converters is a practical necessity for this process. The net result of the foregoing method provides a composite having 6 pages available for advertising. If the sheet is printed only on one side, the composite will suitably have 5 pages available for advertising.

Suitable methods of binding printed sheet into the composite and binding the composite into the magazine include gluing, stitching or stapling. If the magazine has broad appeal and has wide distribution, copies of the magazine containing the advertising can be limited and distributed to a pre-selected demographic group, or simply be otherwise limited for cost considerations. Alternatively, if the magazine has a more limited distribution, or if it is desired to reach all of the subscribers or purchasers, the advertising can be included in all of the copies.

One way of forming the composite is illustrated in U.S. Pat. No. 4,260,444 issued Apr. 7, 1981 to Fowler, which is hereby incorporated by reference. However, the method of Fowler is directed to forming a free standing insert for newspapers which contains a sample product.

Another way of forming the composite is to continuously insert the sheet, such as a tissue sheet, into a v-folded cover sheet (prior to v-folding, the cover sheet is the width of two pages) and gluing the sheet along the edge of the sheet that is positioned against or near the fold. This method results in a v-folded composite that can be easily incorporated into smaller magazines in which the bound edge is stapled.

Those skilled in the art will appreciate there are other ways of producing the composites useful for purposes of this invention. In some embodiments, the sample sheet can be stitched, glued or stapled to a single sheet of advertising and inserted into the magazine, thereby eliminating the need to form a v-folded composite and therefore reduce the number of additional pages of advertising associated with the sheet.

In another aspect, the invention resides in a magazine comprising a bound representative sheet, such as a tissue sheet or a non-woven sheet.

As used herein, the terms “tissue product” or “tissue sheet” mean a facial tissue, bath tissue or a paper towel product or sheet. Tissue products can have one or more plies and particularly include single-ply, two-ply and three-ply products. The individual plies or sheets are low density cellulosic sheets which can be characterized by a bulk of about 3 or more cubic centimeters per gram (cc/g), more specifically from about 5 to about 25 cc/g, and still more specifically from about 5 to about 20 cc/g. Bulk is derived from the basis weight and the single ply caliper, which can be measured by any standard method using a load of 2.0 kPa (132 grams per square inch). Additionally, such sheets can posses a relatively high degree of stretch, particularly in the machine direction, such as from about 5 to about 10 percent stretch. Such individual plies can be made by any method well know to those skilled in the tissue making art, including wet-laying or air-laying, wet-pressed or throughdried, creped or uncreped.

As used herein, a “representative” sheet is a sheet that is structurally the same as the sheet used in the product being advertised, i.e. it is made by the same process as the actual sheet used in the product being advertised, except that it may be of a different size than that used in the actual product and optionally has different graphics or other printing not present on the sheet of the actual product. For tissue sheets, for example, if the pages of the magazine are of a different size than the actual product, it may be preferable to make the size of the representative tissue sheet the same as the size of the other pages of the magazine or slightly smaller. Also, the representative sheet can be provided with printed text and/or graphics associated with advertising. Preferably, the graphics and printing on the representative sheet coordinate or complement the advertising on the preceding and following sheets of the composite, if present. However, in all other respects the representative sheet is the same as the sheet used for making the actual product so that the reader of the magazine can feel what the sheet in or of the actual product feels like. For tissue sheets, a representative tissue sheet can have one or more plies, specifically including two, three or four plies.

In addition, the representative sheet can be printed with a bar code or coupon which can be used by the consumer to obtain actual product or other products. Consistent with the spirit of the advertising graphics or text, the bar code can be printed in the shape of an object, such as a heart, an animal, flower or the like. The use of a coupon or bar code entails further handling of the representative sheet or portions thereof by others (such as cashiers), which furthers the objective of enabling more consumers to appreciate the feel of the product.

As used herein, the term “magazine” means a soft cover bound publication, including catalogs. Typically magazines contain at least 50 pages, more specifically about 100 or more pages. The method of binding the pages within the magazine can include gluing, stitching or stapling the pages along a single common edge.

As used herein, the term “advertising” means text and/or graphics meant to promote the product, such as a tissue product, and which is not present on the actual product being advertised, but is specially provided for purposes of advertising the product in the magazine. Such text and/or graphics can include bar coding that enables the reader to use the sheet or portions thereof as a coupon, which can be redeemed for products at selected retail stores, or other indicia which enable the reader to print coupons using their home computer/printer. Advantageously, the advertising on the representative sheet(s) can complement other advertising within the magazine, particularly if pages of the magazine immediately preceding or following the representative sheet(s) are also directed to advertising the same product or related products.

While a particular embodiment of the invention provides for advertising a single product, such as a paper towel, other embodiments include two or more products, such as a family of products. Such product families can include different commonly-owned brands within the same product category, such as two brands of paper towels, or different products entirely, such as providing representative commonly-owned tissue sheets for facial tissues, bath tissues and paper towels, or various sub-combinations of the above. Alternatively, representative tissue sheets made by different manufacturers can be included to compare the feel of competitive products.

While the invention described herein is particularly applicable to tissue products, it can also apply to other products or product components, such as liner materials for disposable absorbent products such as diapers, training pants, incontinence products, feminine pads and the like. In such cases, the representative sheet can be non-woven sheets and composites. Essentially any sheet material that can contain printed advertising can be used.

It will be appreciated that the foregoing description and examples, given for purposes of illustration, is not to be construed as limiting the scope of this invention, which is defined by the following claims and all equivalents thereto.

We claim:

1. A method of advertising one or more products comprising binding one or more representative sheets within a magazine along only one edge, wherein a reader of the magazine can manipulate the bound sheets in his/her hand to assess hand feel and softness.

2. The method of claim 1 wherein the representative sheet is a non-woven liner material for a disposable absorbent product.

3. The method of claim 1 wherein the representative sheet is a tissue sheet.

4. The method of claim 3 wherein there is only one representative tissue sheet.

5. The method of claim 3 wherein the one or more representative tissue sheets are provided with advertising on only one outer surface.

6. The method of claim 3 wherein the one or more representative tissue sheets are provided with advertising on both outer surfaces.

7. The method of claim 3 wherein the tissue sheet is a paper towel sheet.

8. The method of claim 3 wherein the tissue sheet is a bath tissue sheet.

9. The method of claim 3 wherein the tissue sheet is a facial tissue sheet.

10. A method of advertising a product comprising: (a) forming a roll of a sheet material; (b) unwinding the roll and slitting the unwound sheet into multiple sheets of desired width; (c) winding a slit sheet into a roll; (d) unwinding the sheet and printing at least one side of the sheet with advertising text and/or graphics; (e) slitting the printed sheet to a selected width suitable for use as a page in a magazine; (f) winding a printed/slit sheet into a roll; (g) unwinding the printed sheet and sandwiching and binding the printed sheet between two paper cover sheets along a common edge to form a composite; (h) cutting the composite to a size suitable for being bound into a magazine; and (i) binding the composite into a magazine along the bound common edge of the composite.

11. The method of claim 10 wherein the sheet material is a non-woven liner material for a disposable absorbent product.

12. The method of claim 10 wherein the sheet material is a tissue basesheet and the roll of sheet material is a parent roll.

13. The method of claim 10 wherein the sheet material is glued or stitched into the composite.

14. A magazine comprising multiple pages, wherein at least two consecutive pages are opposite sides of a representative sheet.

15. The magazine of claim 14 wherein the representative sheet is a tissue sheet.

16. The magazine of claim 14 wherein the representative sheet is a non-woven liner material for a disposable absorbent product.
